(19) United States
(12) Patent Application Publication
(10) Pub. No.: US 2014/0074578 A1
(43) Pub. Date: Mar. 13, 2014

(54) METHOD AND SYSTEM FOR ACTIVATING AND VALIDATING COUPONS

(71) Applicant: Bytemark, Inc., New York, NY (US)

(72) Inventors: Micah Bergdale, New York, NY (US); Matthew Grasser, New York, NY (US)

(21) Appl. No.: 14/080,246

(22) Filed: Nov. 14, 2013

Related U.S. Application Data
(63) Continuation-in-part of application No. 13/110,709, filed on May 18, 2011.
Application No. 13/110,709 is a continuation-in-part of application No. 13/046,413, filed on Mar. 11, 2011.
(60) Provisional application No. 61/442,138, filed on Feb. 11, 2011.
(60) Provisional application No. 61/726,481, filed on Nov. 14, 2012.

(51) Int. Cl. G06Q 30/02

(52) U.S. Cl. CPC G06Q 30/0225
USPC 705/14.26

(57) ABSTRACT

This invention discloses a novel system and method for distributing physical coupon cards, each with a unique identifier, that are activated on-line by means of associating the coupon number with an activating user's identity.

### PRIORITY CLAIM

This patent application claims priority to U.S. patent application Ser. No. 13/110,709 filed on May 18, 2011 as a Continuation in Part and hereby incorporates that application by reference in its entirety. This application also claims priority as a Continuation in Part to U.S. patent application Ser. No. 13/046,413 filed on Mar. 11, 2011, which is a nonprovisional continuation of U.S. patent application Ser. No. 61/442,138 filed on Feb. 11, 2011, and hereby incorporates those applications by reference in their entireties. This application claims priority as a non-provisional continuation of Provisional U.S. patent application Ser. No. 61/726,481 filed on Nov. 14, 2012 and herein incorporates that application by reference in its entirety.

### FIELD OF INVENTION

This invention provides a mechanism whereby a series of printed coupons are created, each with a unique identifier, typically a number. The coupons can be validated by a user transmitting the identifier or coupon number to a central server that then associates that identifier or coupon number with that user.

### BACKGROUND

Coupons are a popular way for commercial establishments to market their goods and services to the public. Coupons often appear in printed periodicals or are even given out or left around for consumers to pick up and use. The problem with coupons is that they either offer the consumer too much, that is, they can be re-used or used by the same person, or it is difficult to target with them, or they cannot provide information about who is using the coupon. This invention addresses this need so that coupons can be generated and distributed widely, but closely controlled when in use.

### DESCRIPTION OF THE FIGURES

FIG. 1. Flow Chart for activating a coupon.

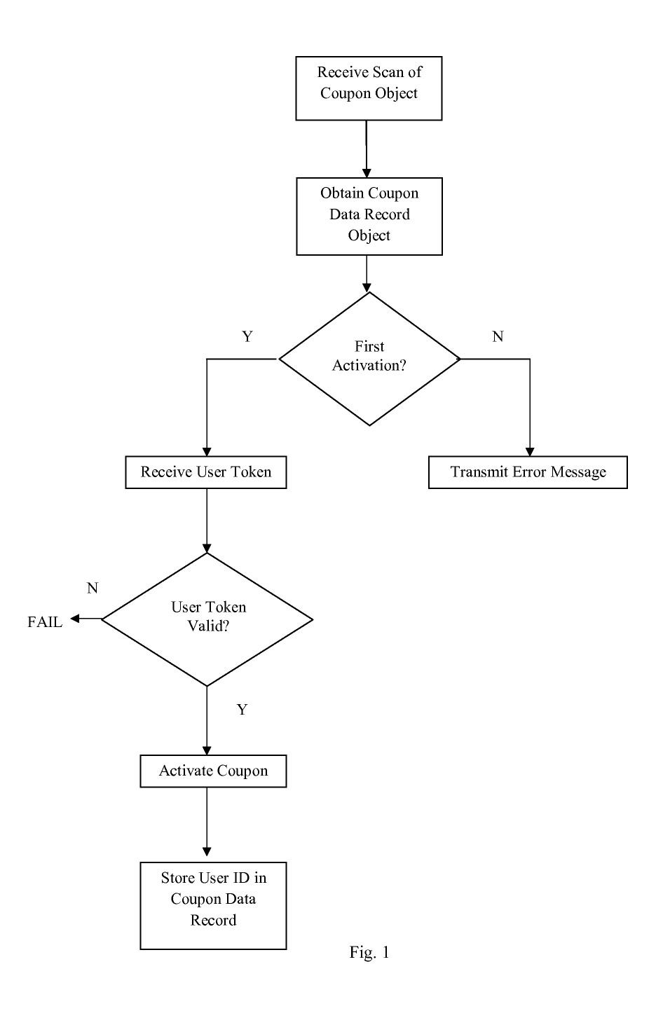

FIG. 2. Flow chart for creating coupons.

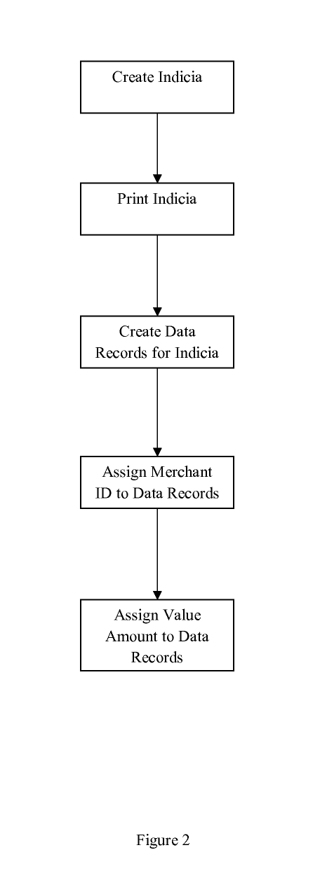

FIG. 3. Flow chart for authentication of user and assigning user to a coupon.

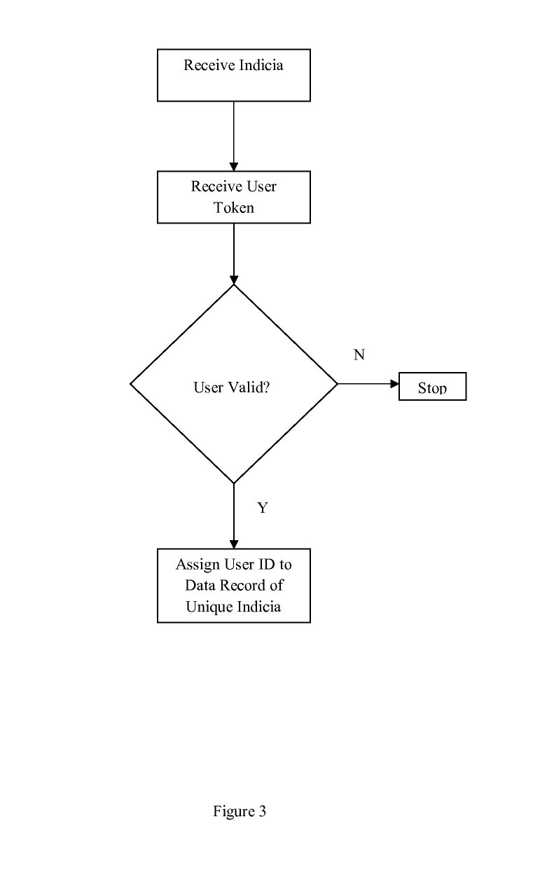

FIG. 4. Flow chart for using the coupon for a purchase.

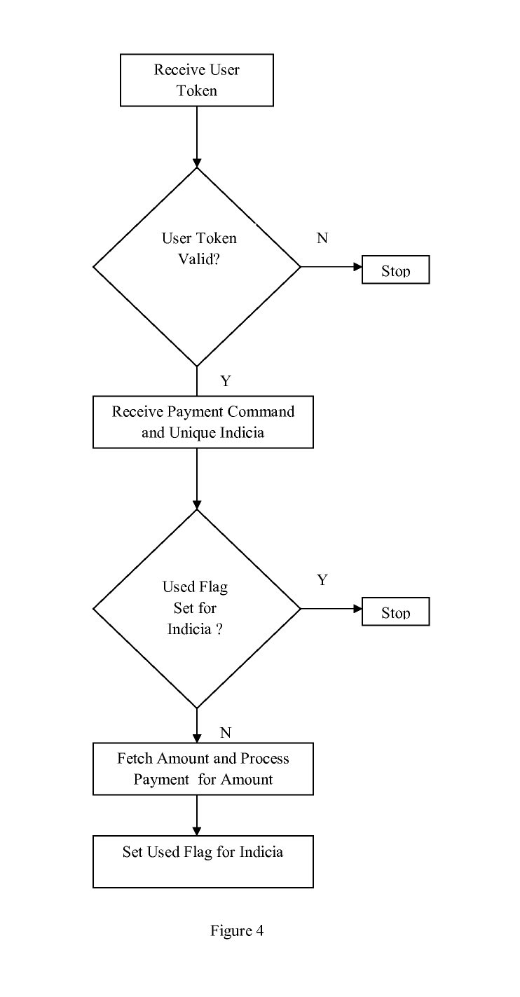

### DETAILED DESCRIPTION OF THE PREFERRED EMBODIMENTS

The system operates on one or more computers, typically one or more file servers acting as a central server connected to the Internet and also on a customer's computing device. A customer's device can be a personal computer, mobile phone, mobile handheld device like a Blackberry™ or iPhone™ or any other kind of computing device a user can use to send and receive data messages.

In one embodiment, a set of random numbers are generated, but these numbers are unauthorized as a coupon but are associated with some merchant, good, service, event or passage or other item of economic value. In one example, the random number can be associated with a discount on a hair-cut at a hair salon. These numbers are transmitted to a system that prints physical cards or other tangible object such that there is one random code number on each card or object. The random numbers could also be QR codes or bar codes or any other unique identifier. The cards can be inserted into a periodical, or distributed in bulk, or handed out on the street. The cards standing alone have no value. In another embodiment, a bar code or QR code is generated for each random number or serial number, and these are printed on the cards or objects.

The next step is to authorize and activate one or more of the cards or physical objects bearing the random code number of QR code. Activation involves first transmitting to a central server the identifier associated with the card, that is, the random number, QR code or bar code and also transmitting the user's validation token in order to associate the user with the coupon and validate it for use. In order to accomplish this, the user has to transmit the code number to a central server. In one embodiment, they will type in the random number appearing on the card into a computer that is connected by a data network to a central server. The number can be typed into a webpage appearing on the user's computer, by means of a browser software, or app, which then transmits the number over the data network. In another, they will scan the QR code or bar code using their telephone or computer and transmit it to a central server. A first test by the server is whether the coupon has already been activated or used. The server uses the numeric code to search in a database comprised of data records, each associated with one of the random numbers or coupons. The data record will contain a flag indicating whether it has been activated and also a flag whether it has been used. The data record will also contain an entry indicating the identity of the authorized user that activated that particular coupon. In that case, that is, if the card is either activated and unused already, or used, the server transmits to the user an error message indicating that the coupon cannot be used.

The user then has to validate the coupon by transmitting the user's secure token to the server. The token can be a password or photo of the user, a fingerprint or any other alphanumeric string that can only be known by the authorized user or held by their authorized device. The server receives the token and then uses the token to check that the user is a valid user. In one embodiment, the token is a password, which the server uses to check whether the user's name matches the password. In another embodiment, public/private key pairs can be used to encrypt the user's token using a private key resident on the user's telephone, and then the paired public key on the server to decrypt the token in order to match it with a stored version on the server. Once the user has been verified, the coupon is activated. This is accomplished by setting the logical value in the data record associated with the coupon to indicate that the coupon is activated, and also updating the data record to have the user's identity associated with that coupon. The system can map the verified user to a user identity by using the data record that matched the user identifier with the validation token, and then providing the user identifier to the coupon database.

In yet another embodiment, the system can check by inspection of the data records to see if the user activating the coupon has already activated another coupon for the same merchant or merchant's offer. In this case, the data record for the coupon number will have the identity of the merchant or an identifier associated with the merchant's discount offer. In this case, the system scans the database to see if other coupons with the same offer identifier have been activated by the same user. In this manner, the virtual coupon can ensure that a given user enjoys one discount from the merchant. In addition, the system can be set up to permit more than one, but some fixed number of uses of the discount offer.

The merchant is being handed a card with a number on it. So the system tells the merchant whether that coupon card is associated it the merchant's offer by comparing an identifier input by the merchant into the system with an identifier (either the merchant identifier or the discount offer identifier) stored in the data record associated with the coupon. If there is a match, the coupon can be honored (unless it has expired, explained further below). In the case of a merchant coupon, the coupon data record will have an entry that includes the identity of the merchant and the amount of credit or discount that the merchant will provide. In this instance, when used, the coupon will also have a validation process with the merchant. The merchant, when presented with the coupon by the customer, will then scan or input the coupon identifier or number into a computer that transmits that information to the central server. The server then checks whether the coupon has been activated or whether it has been activated and used. If the coupon is used, the merchant rejects the discount. If the coupon has not been activated, the merchant can request that the user activate it.

In yet another embodiment, the user may not even be authorized in the system when they seek to activate the coupon. In that case, the system can then require the user to input identifying information into the system to associate them with the coupon they have obtained. In one embodiment, the browser interface may request the user's email address which is transmitted to the server in order to populate the data record of the coupon to indicate the identity of the user for that coupon.

The system and method can also be used to create a form of cash. In this embodiment, the user can purchase a voucher from the service operating the coupon system and receive the token that is used in the coupon validation process. In yet another embodiment, the user can purchase the voucher from the service at the place the user obtains the physical coupon. In yet another embodiment, the same user token may be used, but the user account is debited by the amount being credited to the coupon. In any case, the system then recognizes that the user's token is associated with a certain amount of credit for money value. In that case, the user can then validate a coupon such that the coupon now has an amount of credit associated with that value. In this case, the coupon data record has an entry indicating credit amount. When the user has validated using their token, which is associated with their money credit, the coupon data record can be updated to indicate the credit amount, and the token then deactivated. At this point, the coupon is activated with an amount of credit. The coupon can then be given to anyone, who can then use it for that amount of credit. In this embodiment, the coupon use process does not require that the original user input any token because the credit has already been established. In this manner, the coupon can act as a bearer financial instrument.

In another variation, the user purchases a voucher on-line, gets the token associated with that purchase transmitted down to their device, and then gets a physical card from anywhere. The user can use an iPhone™ or other device to photograph or scan a bar-code or QR code appearing on the physical card and transmit it to the server. They can then input their token in order to associate their voucher amount with the physical card. In any of the disclosed embodiments, scan or photograph of a bar code or QR code can also include using RFID to detect a unique value, NFC or Bluetooth to do the same thing. In another embodiment, the card can be activated at a merchant, who inputs the user's information into a database in order to associate the card with the user and some economic value.

For verification, the mobile device can be used as a source of validating information, for example, by means of an IMEI number, telephone number, email address, or a data value stored in the device by the user that is a password or some other security token.

In yet another embodiment, the coupon is deactivated when it is used. In this case, the holder of the activated coupon presents the coupon to a point of sale for use. The merchant can then access the system and input the coupon code, either by scanning a bar-code or QR code on the physical card or typing in a code number. In any case, the card identifier is transmitted to the server for validation. If it is unused and active, then the server transmits back a confirmation to the merchant. The merchant can than provide a credit to the transaction indicated by the system. In another embodiment, the merchant's point of sale device automatically causes the system to deactivate the card and to transfer the credit associated with the coupon to the account of the merchant. In this case, the coupon use flag in the coupon data record is set to the logical value indicating that the coupon is used. In yet another embodiment, the system can process an electronic payment transaction to the benefit of the merchant for the amount of credit value associated with the coupon, which is known from inspection of the coupon data record.

The use of the virtual coupon provides other advantages. In yet another embodiment, the coupon data record can have an expiration date. In this case, the activation of the coupon is contingent on the expiration date having not occurred. The program logic checks the current date and compares that to the expiration date indicated in the coupon data record. If the current date is later, the system returns an error message. In another case, the coupon can be multi-use, up to the amount of credit associated with the coupon. In this case, a user can purchase credit for the coupon and the system can permit multiple uses of the coupon until the coupon has no remaining value. In this instance, the coupon value has to be checked before completing each transaction in order that the coupon is not overdrawn.

In yet another embodiment, the coupon can be deactivated by the user and the credit re-funded to the user. This may occur if the card is lost or stolen. The user will transmit a request to the system with their validation token. The system will search for all coupons associated with the user (and therefore active) and then deactivate them. In this process, the deactivation will result in refunds being processed to the benefit of the user.

### Operating Environment

The system operates on one or more computers, typically one or more file servers connected to the Internet. The system is typically comprised of a central server that is connected by a data network to a user's computer. The central server may be comprised of one or more computers connected to one or more mass storage devices. A website is a central server that is connected to the Internet. The typical website has one or more files, referred to as web-pages, that are transmitted to a user's computer so that the user's computer displays an interface in dependence on the contents of the web-page file. The web-page file can contain HTML or other data that is rendered by a program operating on the user's computer. That program, referred to as a browser, permits the user to actuate virtual buttons or controls that are displayed by the browser and to input alphanumeric data. The browser operating on the user's computer then transmits values associated with the buttons or other controls and any input alphanumeric strings to the website. The website then processes these inputs, in some cases transmitting back to the user's computer additional data that is displayed by the browser. The precise architecture of the central server does not limit the claimed invention. In addition, the data network may operate with several levels, such that the user's computer is connected through a fire wall to one server, which routes communications to another server that executes the disclosed methods. The precise details of the data network architecture does not limit the claimed invention. Further, the user's computer may be a laptop or desktop type of personal computer. It can also be a cell phone, smart phone or other handheld device. The precise form factor of the user's computer does not limit the claimed invention. In one embodiment, the user's computer is omitted, and instead a separate computing functionality provided that works with the central server. This may be housed in the central server or operatively connected to it. In this case, an operator can take a telephone call from a customer and input into the computing system the customer's data in accordance with the disclosed method. Further, the customer may receive from and transmit data to the central server by means of the Internet, whereby the customer accesses an account using an Internet web-browser and browser displays an interactive webpage operatively connected to the central server. The central server transmits and receives data in response to data and commands transmitted from the browser in response to the customer's actuation of the browser user interface.

A server may be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Practitioners of ordinary skill will recognize that functions that are accomplished on one server may be partitioned and accomplished on multiple servers that are operatively connected by a computer network by means of appropriate inter process communication. In addition, the access of the website can be by means of an Internet browser accessing a secure or public page or by means of a client program running on a local computer that is connected over a computer network to the server. A data message and data upload or download can be delivered over the Internet using typical protocols, including TCP/IP, HTTP, SMTP, RPC, FTP or other kinds of data communication protocols that permit processes running on two remote computers to exchange information by means of digital network communication. As a result a data message can be a data packet transmitted from or received by a computer containing a destination network address, a destination process or application identifier, and data values that can be parsed at the destination computer located at the destination network address by the destination application in order that the relevant data values are extracted and used by the destination application.

It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The method described herein can be executed on a computer system, generally comprised of a central processing unit (CPU) that is operatively connected to a memory device, data input and output circuitry (JO) and computer data network communication circuitry. Computer code executed by the CPU can take data received by the data communication circuitry and store it in the memory device. In addition, the CPU can take data from the I/O circuitry and store it in the memory device. Further, the CPU can take data from a memory device and output it through the IO circuitry or the data communication circuitry. The data stored in memory may be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid state memory.

Examples of well known computing systems, environments, and/or configurations that may be suitable for use with the invention include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as FORTRAN, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The invention may be described in the general context of computer-executable instructions, such as program modules, being executed by a computer. Generally, program modules include routines, programs, objects, components, data structures, etc., that perform particular tasks or implement particular abstract data types. The computer program and data may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card), or other memory device. The computer program and data may be fixed in any form in a signal that is transmittable to a computer using any of various communication technologies, including, but in no way limited to, analog technologies, digital technologies, optical technologies, wireless technologies, networking technologies, and internetworking technologies. The computer program and data may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.) It is appreciated that any of the software components of the present invention may, if desired, be implemented in ROM (read-only memory) form. The software components may, generally, be implemented in hardware, if desired, using conventional techniques. Recitation of data being stored in a data record includes data stored in a flat table, a series of tables or any other database architecture that permits related data to be referenced, including relational databases.

The invention may also be practiced in distributed computing environments where tasks are performed by remote processing devices that are linked through a communications network. In a distributed computing environment, program modules may be located in both local and remote computer storage media including memory storage devices. Practitioners of ordinary skill will recognize that the invention may be executed on one or more computer processors that are linked using a data network, including, for example, the Internet. In another embodiment, different steps of the process can be executed by one or more computers and storage devices geographically separated by connected by a data network in a manner so that they operate together to execute the process steps. In one embodiment, a user's computer can run an application that causes the user's computer to transmit a stream of one or more data packets across a data network to a second computer, referred to here as a server. The server, in turn, may be connected to one or more mass data storage devices where the database is stored. The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer.

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the specification is intended only to provide an extremely detailed disclosure of the present invention and is not intended to be limiting.

Modifications of the above disclosed apparatus and methods which fall within the scope of the invention will be readily apparent to those of ordinary skill in the art. Accordingly, while the present invention has been disclosed in connection with exemplary embodiments thereof, it should be understood that other embodiments may fall within the spirit and scope of the invention, as defined by the following claims.

What is claimed:

1. A computer system for providing virtual coupons comprising:
A module adapted to receive a unique indicia associated with a printed coupon and to receive a validating token from a user;
The system further comprised of a database containing at least one data record associated with the coupon unique indicia, said data record comprised of an entry for a merchant identifier and further adapted to update the data record associated with the coupon unique indicia to include a user identifier associated with the user.

2. The system of claim 1 where the system is further adapted to include a credit value amount in the data record associated with the unique indicia.

3. The system of claim 2 where the system is further adapted to include a used flag in the data record associated with the unique indicia.

4. The system of claim 2, where the system is further comprised of a payment module that is adapted to receive a command to process a payment for a predetermined payment amount, and cause the system to update the credit value amount in the data record by deducting the payment amount, said command dependent on the payment system verifying the payment command authorization.

5. The system of claim 3, where the system is further comprised of a payment module that is adapted to receive a command to process a payment for the payment amount indicated in the data record, and cause the system to update the used flag to indicate a used condition, said command dependent on the payment system verifying the payment command authorization.

6. The system of claim 4 or 5 where the payment module is adapted to retrieve the merchant identifier and process the payment by causing a credit to be posted to an account of the merchant associated with the merchant identifier.

7. The system of claim 6 where the system is further adapted to include an expiration date in the data record associated with the unique indicia, determine the date of the payment command is received and process the payment in dependence on whether the determined date is after the expiration date.

8. A method executed by a computer system for processing virtual coupons comprising:
Creating a plurality of unique indicia;
Storing in a database a plurality of data records corresponding to each of the plurality of unique indicia, each of said data records comprised of its corresponding unique indicia;
Storing in the plurality of data records at least one merchant identifier to be associated with the plurality of unique indicia;
Receiving a unique indicia;
Receiving a validating token from a user;
In dependence on validating the received token, storing in the data record associated with the unique indicia a reference to the user associated with the received token.

9. The system of claim 8 further comprising storing at least one credit value amount in at least one corresponding data records associated with the plurality of unique indicia.

10. The system of claim 8 further comprising storing at least one expiration date in at least one corresponding data records associated with the plurality of unique indicia.

11. The system of claim 8 further comprising storing at least one used flag in at least one corresponding data records associated with the plurality of unique indicia.

12. The method of any of claims 8 through 11, further comprising:
Receiving a command to process a payment for a predetermined payment amount for at least one unique indicia, and
Updating the credit value amount in the data record associated with the unique indicia by deducting the payment amount, said command dependent on receiving a verified payment authorization command.

13. The method of claim 12 further comprising:
retrieving the merchant identifier associated with the unique indicia and processing the payment by causing a credit to be posted to an account of the merchant associated with the retrieved merchant identifier.

14. The method of claim 11 further comprising the steps of
retrieving the used flag value;
determining if the retrieved value indicates the coupon has been used; and
in dependence on the determination, preventing a payment process using the coupon.

15. The method of claim 11 further comprising the steps of
Processing a payment in the amount of a credit value stored in the data record and updating the used flag to indicate that the coupon is used.
